(19) United States
(12) Patent Application Publication
(10) Pub. No.: US 2004/0059637 A1
(43) Pub. Date: Mar. 25, 2004

(54) System and method of auction

(76) Inventor: Dohyun Jung, Seoul (KR)

Correspondence Address: DARBY & DARBY P.C., P. O. BOX 5257, NEW YORK, NY, 10150-5257, US

(21) Appl. No.: 10/311,086

(22) PCT Filed: Jun. 20, 2001
(86) PCT No.: PCT/KR01/01052

(30) Foreign Application Priority Data
Jun. 20, 2000 (KR) 2000/33853

(51) Int. Cl. G06F 17/60

(52) U.S. Cl. 705/26

(57) ABSTRACT

Disclosed are on-line auction system and an on-line auction method, in which a seller can distribute purchase orders according to the production schedule and can sell the goods at higher prices, and a bidder can receive the goods he wants to purchase at a time he wants. In the auction system and the auction method, if an excessive demand is detected, a seller registers information of goods to be produced and a bidder registers demand information about goods the bidder wants to purchase. When there exists an excessive demand, conducted is an auction, including an order caused the excessive demand and orders still in a waiting state. Then, an order with the lowest bid price is excluded from the auction, while orders in the waiting state after a predetermined time has passed are converted to production-determined orders.

### TECHNICAL FIELD

The present invention relates to an on-line auction system and an on-line auction method for distributing purchase orders according to a production schedule of a seller, and more particularly to an auction system and an auction method utilizing the auction system, in which a seller can distribute purchase orders according to the production schedule and can sell the goods at higher prices by conducting an auction according to an excessive demand when the excessive demand appears, and a bidder can receive the goods he wants to purchase at a time he wants only if he makes a bid with the higher price in the auction. In the auction system and method of the invention, if there exists an excessive demand is detected, after a seller registers information of goods to be produced, including the quantity of the goods, a schedule, the starting price, and a waiting time until the order is determined, and a bidder registers a name and a quantity of goods to be purchased, a requested delivery date, a purchase price, and a bid price. When there exists an excessive demand, an auction is conducted with an order caused the excessive demand together with orders still in the waiting state, so that an order with the lowest bid price is excluded from the auction while the waiting orders after a predetermined time has passed are converted to the production determined orders.

### BACKGROUND ART

Nowadays, according to the development of telecommunication technology, on-line methods of selling or purchasing goods have been universalized and are utilized as means for a standard auction, a reverse auction (Dutch auction), and a purchase by a group of cooperative bidders. As representative standard auction or reverse auction services, there are Auction (www.auction.co.kr), Samsung Auction (www.samsungauction.com), Waawaa (www.waawaa.com), and Sellpia (pas.sellpia.com) in Korea, and eBay (www.ebay.com) and Priceline (www.priceline.com) in USA.

In general auction systems, auction is conducted according to bidders, who offer prices higher than a posted bid price, or according to limited quantity of goods, so that the other bidders except one who offers the highest bid price lose an opportunity of purchasing goods and can't buy goods which they want. That is to say, only one bidder can make a winning bid for one case of goods sale. Or even if it is possible, bidders must participate in auction within specific bidding period. This might bring limitation of bidders to participate in the auction.

Further, Korean patent laid-open publication No. 2000-23939 discloses an auction method of a cooperative purchase type, in which after a seller posts an auction price for corresponding goods, applications from groups of cooperative bidders who want to purchase the same article of goods at a price lower than the posted auction price are received and posted. Then, in the disclosed method, even allowed is a bid at a price induced by the number of the cooperative bidders, which is lower than the initial auction price posted by the seller. Therefore, the disclosed method enables the bidders to purchase the goods at a lower price formed by two factors of the cooperative purchase and the competition.

However, in the conventional auction services or the disclosed patent application, only the goods already manufactured are auctioned, but goods or services manufactured or provided according to a scheduled production cannot be auctioned in order to sell or purchase the goods or the services. Further, in the prior arts, only a specific quantity of goods can be registered and sold, so that the prior arts show their own limits.

### DISCLOSURE OF THE INVENTION

Accordingly, the present invention has been made in an effort to solve the problems occurring in the related art, and it is an object of the present invention to provide an auction system and an auction method utilizing the auction system, in which, in industries in which goods are purchased and sold according to a scheduled production, a seller can distribute purchase orders according to the production schedule and can sell the goods at higher prices by conducting an auction according to an excessive demand when the excessive demand appears, and a bidder can receive the goods he wants to purchase at a time he wants only if he makes a bid with a high price in the auction, which means the auction system and the auction method have a characteristic of price changeability.

It is another object of the present invention to provide an auction system and an auction method utilizing the auction system, in which goods can be sold to a plurality of bidders, the same goods can be continuously sold as long as the production schedule permits, and the seller can supply the goods to a purchaser at a delivery date the purchaser has appointed, according to the production schedule of the seller.

In accordance with one aspect, the present invention provides an auction system comprising at least one terminal, a server, and an open-type network, the server comprising: a goods database section for storing sales information of goods which a seller want to sell; an order database section for storing purchase order information of registered selling goods which a bidder wants to purchase; a selling goods register module for storing information about goods to be sold through input means of the terminal or the server in the goods database section; a purchase order register and change module for storing purchase order information about goods to be purchased through the input means of the terminal in the order database section and for changing already registered information; a production schedule arranging module for arranging a production schedule for the goods according to the purchase order information registered or changed by the purchase order register and change module; a purchase waiting order assigning module for determining an order, whose production schedule has been arranged by the production schedule arranging module, as a purchase waiting order; a purchase determined order selecting module for selecting a purchase determined order from purchase waiting orders; an auction order selecting module for selecting an order, whose production schedule is arranged before a production initiating date and a delivery date of an excessive demand inducing order, as an auction order; and an auction module for comparing unit bid prices of auction orders selected by the auction order selecting module one after another, so as to exclude an order with a lowest bid price, judging if there exists an excessive demand by remaining orders except the order of the lowest price, and progressing an auction again when there exists the excessive demand while classifying the remaining orders into purchase waiting orders when the excessive demand does not exist.

The server further may comprise a schedule optimizing module for optimizing an arrangement of the production schedule in the system by rearranging the production schedule to be before and near a requested delivery date in already registered order information of a bidder, when there happen factors of changing the demand and/or supply due to reasons including a participation of a new order into the auction after the production schedule is arranged, an exclusion of an order while the auction progresses, a change in the ordered quantity of goods or a withdrawal of the order by a bidder, and a change in the produced quantity of goods by the seller. The server also may comprise an auction possibility judging module for judging if an excessive demand inducing order, for which a production schedule is not arranged by the production schedule arranging module, can participate in the auction, and for notifying that the excessive demand inducing order cannot participate in the auction and that the order has to be changed, when the auction is impossible.

The goods database section may store information including at least one of names of goods and/or services to be sold by a seller, descriptions about the goods and/or services, expected daily producing quantities of the goods, production schedule, expected waiting time for the purchase determination, a closing date of the sale, and unit sold starting prices of the goods, and the order database section stores information including at least one of names and unit bid prices of goods to be purchased, a delivery date, a purchased quantity of goods, and a processing state of the order.

When the already registered information is changed by the purchase order register and change module, at least one of labors, which include reducing a quantity of goods to be purchased, delaying the delivery date, and elevating the unit auction price, is carried out, while a waiting time in an initial stage of registering the order is maintained.

The production schedule arranging module arranges a production schedule of purchasing orders with a continuity of time or intermittently.

The purchase determined order selecting module selects a purchase determined order, when a purchasing order's waiting time has passed without competition or still remains at the bidding so that it is time of change from a purchase waiting order into the purchase determined order, or when the seller manually changes an order into the purchase determined order.

In a case where the order of the lowest price is selected by the auction module, an order with a smallest quantity is selected as the order of the lowest price when there exist at least two orders whose prices are lowest, while an order registered most lately is selected as the order of the lowest price when there exist at least two orders whose prices are lowest and whose quantities are the same.

In accordance with another aspect, the present invention provides an auction method by means of an auction system, the auction system comprising at least one terminal, a server, and an open-type network, the method comprising: a selling goods register step, in which a seller inputs information about goods and/or service to be sold; a purchase order register and change step, in which a bidder inputs purchase order information about goods and/or services which the bidder wants to purchase and changes already registered information; a production schedule arranging step, in which the server arranges a production schedule for the goods according to the purchase order information registered or changed in the purchase order register and change step; a purchase waiting order assigning step, in which an order whose production schedule has been arranged in the production schedule arranging step is defined as a purchase waiting order; a purchase determined order selecting step, in which a purchase determined order is selected from purchase waiting orders; an auction order selecting step, in which an order, whose production schedule is already arranged between a production initiating date and a delivery date of an excessive demand inducing order, and the excessive demand inducing order are selected as auction orders; and an auction step, in which an auction is conducted for the auction orders selected in the auction order selecting step, so as to exclude an auction order with a lowest bid price, if there exists an excessive demand by remaining orders except the order of the lowest price is judged, and the auction is conducted again when there exists the excessive demand while the remaining orders are classified into purchase waiting orders when the excessive demand does not exist.

The method may further comprise a schedule optimizing step, in which the production schedule in already registered order information of a bidder is rearranged to be before and near each requested delivery date, so that an arrangement of the production schedule is optimized, when there happen factors of changing the demand and supply due to reasons including a participation of a new order into the auction before an execution of the production schedule arranging step or after an execution of the auction step, an exclusion of an order while the auction progresses, a change in the ordered quantity of goods or a withdrawal of the order by a bidder, and a change in the produced quantity of goods by the seller.

Also, the method may further comprise an auction possibility judging step, in which if an excessive demand inducing order, for which a production schedule is not arranged in the production schedule arranging step, can participate in the auction is judged, and that the excessive demand inducing order cannot participate in the auction and that the order has to be changed are notified when the auction is impossible.

First information inputted in the selling goods register step includes at least one of names of goods and services to be sold by a seller, descriptions about the goods, daily produced quantities of the goods, waiting time for the purchase determination, a closing date of the sale, and unit sold prices of the goods. Also, second information inputted or changed in the purchase order register and change step includes at least one of names and unit bid prices of goods to be purchased, a delivery date, a purchased quantity of goods, and a processing state of the order.

At least one of labors, which include reducing a quantity of goods to be purchased, delaying the delivery date, and elevating the unit auction price, can be carried out, while a waiting time in an initial stage of registering the order is maintained, when the already registered information is changed in the purchase order register and change step.

In the production schedule arranging step, a production schedule of an order is arranged with a continuity of time or intermittently.

In the purchase determined order selecting step, a purchase determined order is determined, when a purchase waiting time has passed so that it is time of change from a purchase waiting order into the purchase determined order, or when the seller manually changes an order into the purchase determined order.

In a case where the order of the lowest price is selected in the auction step, an order with a smallest quantity is selected as the order of the lowest price when there exist at least two orders whose prices are lowest, while an order registered most lately is selected as the order of the lowest price when there exist at least two orders whose prices are lowest and whose quantities are the same.

In accordance with another aspect, the present invention provides a reverse auction system comprising at least one terminal, a server, and an open-type network, the server comprising: a goods database section for storing purchase information of goods which a bidder want to purchase; an order database section for storing sales order information of registered goods which a seller wants to sell; a purchase goods register module for storing information about goods to be purchased through input means of the terminal in the goods database section; a sales order register and change module for storing sales order information about goods to be sold through the input means of the terminal in the order database section and for changing already registered information; a purchase schedule arranging module for arranging a purchase schedule for the goods according to the sales order information registered or changed by the sales order register and change module; a sales waiting order assigning module for determining an order, whose purchase schedule has been arranged by the purchase schedule arranging module, as a sales waiting order; a sales determined order selecting module for selecting a sales determined order from sales waiting orders; a reverse auction order selecting module for selecting an order, whose goods sales quantity is arranged after a delivery date, from the sales waiting orders, as a reverse auction order, and a reverse auction module for comparing unit sales prices of reverse auction orders seected by the reverse auction order selecting module one after another, so as to exclude an order with a highest sales price, judging if it is possible to conduct the reverse auction with remaining reverse auction orders except the order of the highest sales price, and progressing a reverse auction again when there exists an excessive supply while classifying the remaining orders into sales waiting orders when the excessive supply does not exist.

The server may further comprise a schedule optimizing module for optimizing an arrangement of the production schedule in the system by rearranging the production schedule to be after and near a requested delivery date in already registered order information of a bidder, when there happen factors of changing the demand and supply due to reasons including a participation of a new order into the reverse auction after the purchase schedule is arranged, an exclusion of an order while the reverse auction progresses, a change in the quantity of selling goods or a withdrawal of a sales order by a seller, and a change in the ordered quantity of goods by the bidder.

Also, the server may further comprise a reverse auction possibility judging module for judging if an excessive supply inducing order, for which a purchase schedule is not arranged by the purchase schedule arranging module, can participate in the reverse auction, and for notifying that the excessive supply inducing order cannot participate in the reverse auction and that the order has to be changed by reducing the quantity of goods, advancing a supply date, or lowering the price, when the reverse auction is impossible.

In accordance with another aspect, the present invention provides a reverse auction method by means of a reverse auction system, the reverse auction system comprising at least one terminal, a server, and an open-type network, the method comprising: a purchase goods register step, in which provided is a screen, through which a bidder who wants to purchase goods can input information about the goods to be purchased; a sales order register and change step, in which provided is a screen, through which a seller can input sales order information about goods, which the seller wants to sell, and can change already registered information; a purchase schedule arranging step, in which the server arranges a purchase schedule for the order registered or changed in the sales order register and change step; a sales waiting order assigning step, in which the order whose purchase schedule has been arranged in the purchase schedule arranging step is defined as a sales waiting order; a sales determined order selecting step, in which a sales determined order is selected from sales waiting orders; a reverse auction order selecting step, in which sales orders, whose supplying quantity is already arranged after a delivery date of an excessive supply inducing order, and the excessive supply inducing order are selected as reverse auction orders; and a reverse auction step, in which a reverse auction is conducted for the reverse auction orders selected in the reverse auction order selecting step, so as to exclude a reverse auction order with a highest sales price, if there exists an excessive supply by remaining orders except the order of the highest sales price is judged, and the reverse auction is conducted again when there exists the excessive supply while the remaining orders are classified into sales waiting orders when the excessive supply does not exist.

The method may further comprise a schedule optimizing step, in which the purchase schedule is rearranged to be after and near a requested delivery date in already registered sales order information of a seller, so that an arrangement of the purchase schedule is optimized, when there happen factors of canging the demand and supply due to reasons including a participation of a new order into the reverse auction before an execution of the purchase schedule arranging step or after an execution of the reverse auction step, an exclusion of a sales order while the reverse auction progresses, a change in the sales quantity of goods or a withdrawal of the sales order by a seller, and a change in the purchased quantity of goods by the purchaser.

Also, the method may further comprise a reverse auction possibility judging step, in which, when there exists an excessive supply inducing order, for which a purchase schedule is not arranged in the purchase schedule arranging step, if the excessive supply inducing order can participate in the reverse auction is judged, and that the excessive supply inducing order cannot participate in the reverse auction and that the sales order has to be changed are notified when the reverse auction is impossible.

When goods are produced according to a schedule, some of the goods may gather purchasers while others of goods may have no purchaser. In the auction system and method of the present invention, when the production schedule is busy, the orders are induced to be reduced or to be presented again later in an unoccupied time. When such a change of orders is impossible, an auction is conducted between the waiting orders, so that an order with the lowest price is excluded from the auction. In result, the seller can make a profit through the high sales price, while the purchase can purchase the goods at a time he wants at the expense of the high price.

### BRIEF DESCRIPTION OF THE DRAWINGS

The above objects, and other features and advantages of the present invention will become more apparent after a reading of the following detailed description when taken in conjunction with the drawings, in which:

FIG. 1 is a schematic view for showing a construction of an auction system according to an embodiment of the present invention;

FIG. 2 is a flow chart of an auction method according to another embodiment of the present invention; and

FIG. 3 is a flow chart of a schedule optimizing routine in the auction method shown in FIG. 2.

### BEST MODE FOR CARRYING OUT THE INVENTION

The above and other objects, characteristics, and advantages of the present invention will be apparent from the following description along with the accompanying drawings.

In the following description, terms are defined as follows.

That is, a “delivery date” means a date, at which a bidder wants to receive goods he orders. A “production initiating date” means a date, at which a seller starts to produce goods, and which is recorded as a reference detail when the seller registers the goods to be sold.

An “excessive demand inducing order” means a purchase order, for which a production schedule cannot be arranged when the production schedule is temporarily arranged for the purchase order after the bidder registers the purchase order.

A “purchase waiting order” means an order, which has represented and registered an intention to purchase the goods but is still waiting until a purchase of the goods is allowed or determined.

A “purchase determined order” means an order, for which the purchase of goods is determined. The purchase waiting orders are classified into the purchase determined orders, when a purchase waiting time or the time of change from a purchase waiting order into the purchase determined order, which has been recorded when the seller registers the goods to be sold and the waiting time has passed without dropout of the bidding, has passed, or when the seller manually changes the order into the purchase determined order according to the seller's necessity.

An “auction order” means an order, which can participate in an auction and selected from the purchase waiting orders or the excessive demand inducing orders, except the orders classified into the purchase determined orders. Conditions, on which an order can participate in an auction, can be determined by the seller or the server operator.

A “unit sales price” means a starting price, at which the seller wants to sell an article of goods.

A “unit purchase price” is a price equal to or higher than the unit sales price. The seller of goods may convert an order, which has a large quantity of purchased goods or whose unit purchase price is higher than the unit sales price, to the purchase determined order in a shorter time.

An “unit auction price” is a price to be presented while an auction is conducted after an excessive demand inducing order appears. A plurality of unit auction prices may be simultaneously presented. When a bid price in a bidder's order is the lowest price, the bidder can present another price higher than the prior price the bidder has presented so that the bidder's order may not be excluded from the auction. It is preferred that such an auction as described above can be automatically conducted on the basis of the unit auction prices recorded in the orders.

A “terminal” includes mobile phones such as a cellular phone, a personal communication service (PCS) phone, a personal digital assistant (PDA), and an international mobile telecommunications for 2000 (IMT2000) terminal, and computers such as a personal computer, a notebook computer, and a portable personal computer.

An “open-type network” includes the Internet network, an Internet network combined with a telephone network, and a local network interconnected to the Internet network and the telephone network.

Those terms as described above are used with the same meanings throughout the present specification.

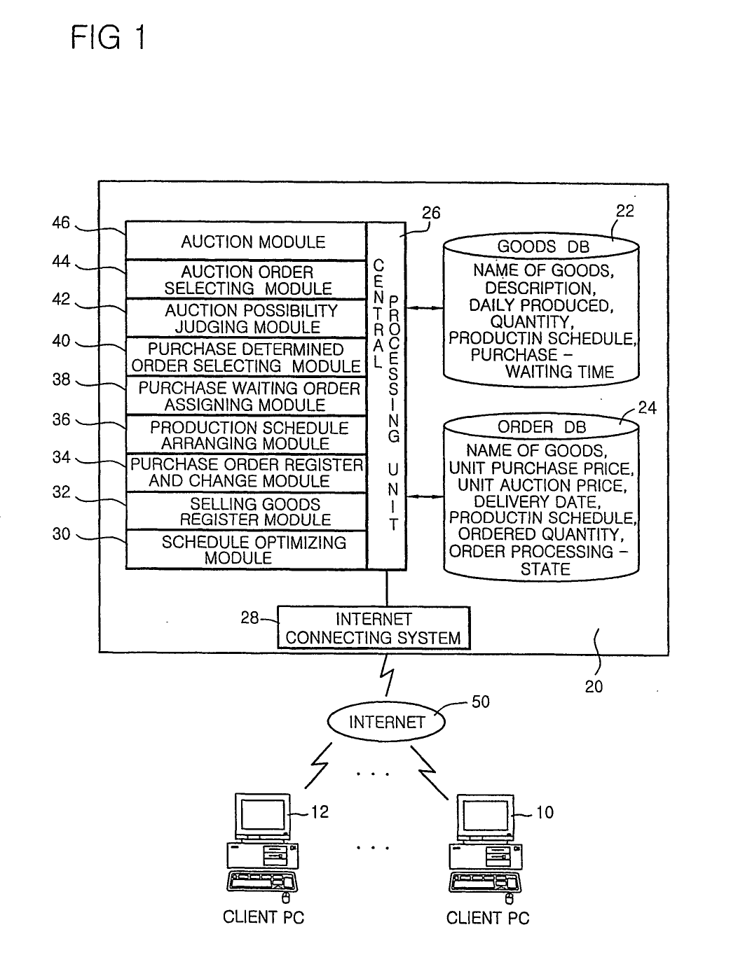

FIG. 1 is a schematic view for showing a construction of an auction system according to an embodiment of the present invention.

The action system according to an embodiment of the present invention includes client personal computers 10 and 12, a server 20, and the Internet network 50 interconnecting the client computers and the server so as to enable a data telecommunication between them.

The server 20 includes typical components of a computer system, such as a central processing unit 26, a goods database section 22, and an order database section 24. Further, the server includes a selling goods rgister module 32, a purchase order register and change module 34, a production schedule arranging module 36, a purchase waiting order assigning module 38, a purchase determined order selecting module 40, an auction possibility judging module 42, an auction order selecting module 44, an auction module 46, and a schedule optimizing module 30.

The goods database section 22 stores information including names of goods or services to be sold by a seller, descriptions about the goods, daily produced quantities of the goods, waiting time for the purchase, a closing date of the sale, and unit sold prices of the goods. The information is registered by the seller or a server operator in behalf of the seller.

The order database section 24 stores information including names and unit purchase prices of goods, which bidders want to purchase, a plurality of unit auction prices of goods, which are to be posted when the goods are auctioned, delivery dates, at which the bidders want to receive the goods, and order quantities, by which the bidders order the goods. This information is inputted through input means of the client personal computers by the bidders. Further, the order database section 24 has a construction, in which states of processing the orders can be recorded and renewed by the server operator or the seller.

When the seller registers goods to be sold through the input means of the client personal computer 10, the selling goods register module 32 functions to store the information about the goods to be sold in the goods database section 22.

When a bidder registers goods, which he or she wants to purchase, through the input means of the client personal computer 10, the purchase order register and change module 34 functions to store the information about the goods to be purchased in the order database section 24. Further, when an details of the order has to be changed since the order cannot be auctioned according to a judgment of the auction possibility judging module 42 or is judged as an order of the lowest bid price, the purchase order register and change module 34 functions to renew the information in the order database section 24 into the changed details. When the renewal of the information is performed, at least one of the labors, which include reducing the quantity of goods to be purchased, delaying the date of delivery, and elevating the unit auction price, is carried out, while a waiting time in the initial stage of registering the order is maintained.

The production schedule arranging module 36, which is a module for arranging a production schedule for the purchase order whose details are registered by the purchase order register and change module 34, arranges the production schedule for the order to be in accordance with a production schedule in the order database section 24 and stores the arranged production schedule in the order database section 24. Otherwise, the production schedules in the goods database section 22 and in the order database section may be arranged respectively. The production schedule may be arranged with a continuity of time or intermittently.

The purchase waiting order assigning module 38 functions to determine the order, whose production schedule has been arranged by the production schedule arranging module, as a purchase waiting order, which is recorded in an order processing state field in the order database section 24.

The purchase determined order selecting module 40 changes the order processing state in the order database section 24 into a state of a purchase determined order, when a purchase waiting time has passed without dropout of the bidding so that it is time of change from a purchase waiting order into the purchase determined order, or when the seller manually changes the order into the purchase determined order.

The auction possibility judging module 42 is a module for judging if an order, which is separated as an excessive demand inducing order since a production schedule is not arranged for the order by the production schedule arranging module 36, can participate in the auction or not. This judgment can be made when there is a purchase waiting order whose production schedule is arranged between a production initiating date and a delivery date of the excessive demand inducing order, and the auction can be conducted when a production according to the excessive demand inducing order is possible in the case where one or at least one of the purchase waiting orders is excluded from the auction. When the auction is impossible, that the excessive demand inducing order cannot participate in the auction and that the order has to be changed are notified.

The auction order selecting module 44 selects the excessive demand inducing order, which the auction possibility judging module 42 has judged as being capable of being auctioned, and the purchase waiting order, whose production schedule is arranged between the production initiating date and the delivery date of the excessive demand inducing order, as auction orders, and renews the order processing state field in the order database section 24 according to the auction orders.

The auction module 46 functions to compare unit bid prices of the auction orders selected by the auction order selecting module 44 one after another, so as to exclude an order with the lowest bid price from the auction according to a principle of the auction. According to the principle of the auction, an order with the lowest bid price is excluded from the auction after comparing unit auction prices recorded in the purchase orders, and a bidder of the order with the lowest price can participate again in the auction with a higher bid price in the case where there is further arranged an automatic process in which the bidder can present a higher bid price when his or her prior bid price is the lowest bid price. When the excessive demand does not disappear even after excluding the order with the lowest bid price, the auction module 46 repeats the process of excluding the order with the lowest bid price until the excessive demand disappears.

Further, the schedule optimizing module 30 is a module, which optimizes the arrangement of the production schedule in the system by rearranging the production schedule, when there happen factors of changing the demand and supply due to reasons including a participation of a new order into the auction after the production schedule is arranged, an exclusion of an order during the progress of the auction, a change in the ordered quantity of goods or a withdrawal of the order by a bidder, and a change in the produced quantity of goods by the seller. This module rearranges the production schedule to be before and near the requested delivery date in already registered order information of a bidder, when a new order participates into the auction before an execution of the production schedule arranging module or after an execution of the auction module, when an order is excluded during the progress of the auction, when a bidder changes the ordered quantity of goods or withdraws the order, or when there happen other factors of changing the demand and supply due to a reduction of productivity by a national calamity or an increase of productivity according to an improvement of technology.

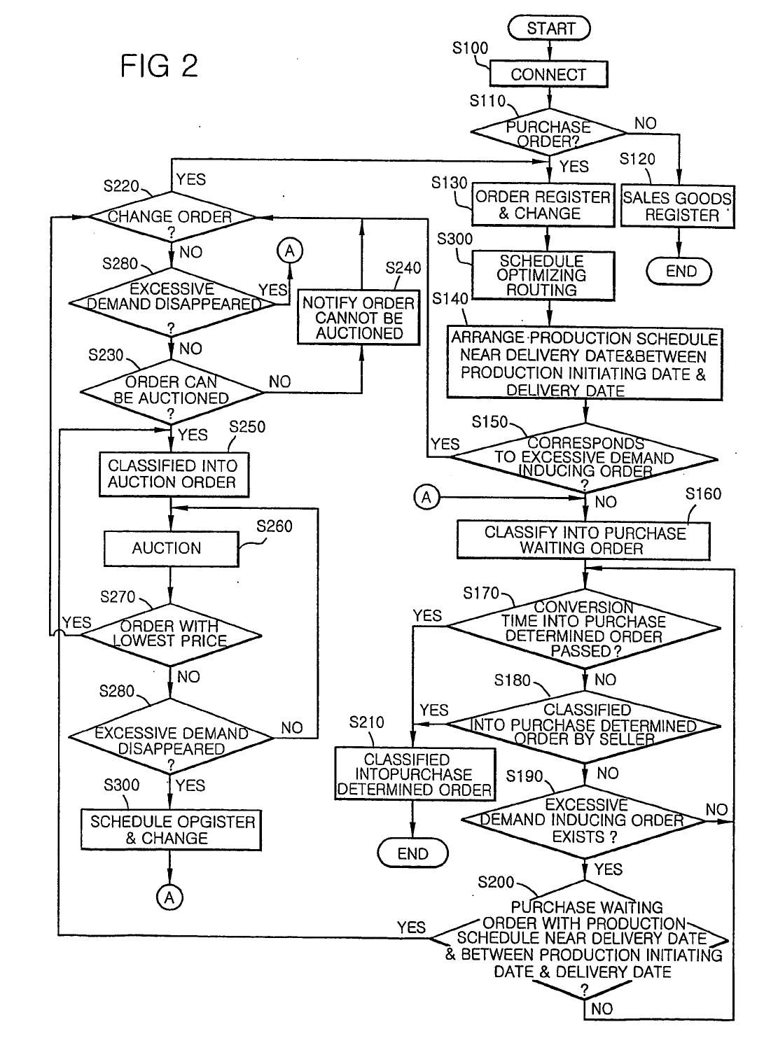

FIG. 2 is a flow chart of an auction method according to another embodiment of the present invention.

In the method, when a client 10 or 12 connects with the server 20 of the auction system of the present invention (S100), the server asks the client whether the client will register a purchase order or goods to be sold (S110). In this case, a selling goods register step is carried out when the client 10 or 12 want to register the goods to be sold (S120), while a purchase order register step is carried out when the client want to register the purchase order (S130).

Then, a production schedule for an order registered in the order register step S130 is arranged for a production schedule of selling goods registered in the selling goods register step S120 (S140).

The purchase order provided with a production schedule in the production schedule arranging step S140 is classified into a purchase waiting order (S160). In this case, if the order is provided with a condition to be classified into a purchase determined order and if there happens an excessive demand are continuously confirmed (S150).

When the order classified into the purchase waiting order in the above purchase waiting order assigning steps S150 and S160 is provided with the condition to be classified into the purchase determined order, the purchase waiting order is classified into the purchase determined order (purchase determined order assigning steps; S170, S180, and S200).

An order, which is not provided with a production schedule in the production schedule arranging step S140, corresponds to an excessive demand inducing order. When the order has been confirmed as the excessive demand inducing order in the step S150 of confirming if an order corresponds to the excessive demand inducing order, a change of the order is requested (S220). When there is a response to change the order, the process comes back to the order register and change step S130. On the contrary, when the client responds not to change the order, then whether the order can participate in the auction or not is judged (S230). If it is possible to auction according to the result of the judgment, the order is determined as an auction order when the order can participate in the auction (S250), while that the order cannot participate in the auction is notified and a change of the order is requested.

In response to the above request, when the client 10 or 12 amends the details of the order such as a reduction of the ordered quantity of goods, an increase of the price, and/or a delay of the delivery date, the purchase order changing step S130 is carried out.

When the information changed through the selling goods changing step S120 has been inputted, a rearrangement is performed through a schedule optimizing step S300, in which the production schedule of the selling goods already arranged on the basis of the amended information is amended again into an optimum condition on the basis of the changed information.

However, when the client 10 or 12 does not want to change the details of the order despite the request for the change of the order in the step S220, the classification into the auction order is deferred until an auction according to other's amendment is possible (S280), and the step S250 of determining the auction order progresses when the auction is possible.

In the auction steps S260 to S280, the process of excluding the order with the lowest bid price from the auction is repeated until the state of the excessive demand disappears. When the excessive demand has disappeared, the process is ended.

When an excessive demand inducing order happens in the auction possibility judging steps S230 and S240, any purchase waiting order provided with a production schedule between the production initiating date and the delivery date of the excessive demand inducing order, is classified into the auction order (auction order classifying steps S250 and S200). At the same time, the excessive demand inducing order is also classified into the auction order.

Thereafter, the auction is conducted with the bid orders, which are classified into the auction orders in the auction order classifying steps S250 and S200 (auction steps S260 to S280). In the auction steps, the unit auction prices of the bid orders classified into the auction orders are compared each other, so that the bid order with the lowest price is excluded from the auction according to the auction principle.

According to the principle of the auction, an order with the lowest bid price is excluded from the auction after comparing unit auction prices recorded in the purchase orders, and a bidder of the order with the lowest price can participate again in the auction with a higher bid price in the case where there is further arranged an automatic process in which the bidder can present a higher bid price when his or her prior bid price is the lowest bid price.

In the auction steps S260 to S280, when the excessive demand does not disappear even after excluding the order with the lowest bid price, the process of excluding the order with the lowest bid price among the remaining orders is repeated until the excessive demand disappears. When the excessive demand has disappeared, the production schedule of purchasing orders is rearranged to be before near each requested delivery date by conducting the schedule optimizing routine S300 in consideration of factors changing the production schedule as described above.

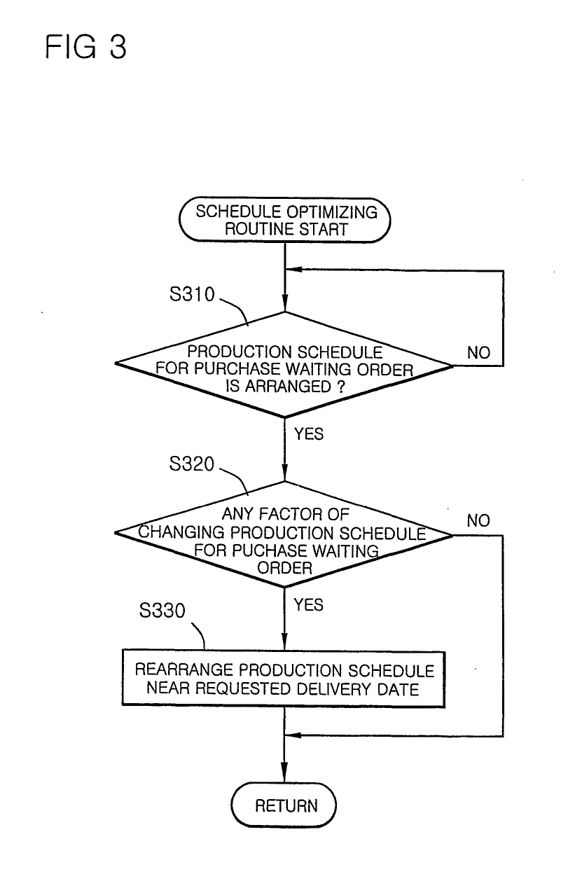

In the schedule optimizing routine S300, as shown in detail in FIG. 3, if an arrangement of the production schedule for the purchase waiting order has been completed is judged in step S310, and if there is a factor for changing the production schedule due to an exclusion and an addition of an order is judged in step S320. Then, when there is a factor for changing the production schedule, the production schedule is rearranged to be prior to the requested delivery date (S330).

Although FIGS. 1 and 2 show the case where the seller of the goods requests the auction, it is apparent that the same process and the same system may be employed in the reverse auction, in which buyers who want to purchase the goods request the auction. In the latter case, the words, selling and purchase, in FIGS. 1 and 2, are switched each other, and the production schedule is changed to a purchase schedule, so that the reverse auction can be progressed, the description of which will be omitted since those skilled in the art can easily understand the reverse auction from the above description of the standard auction. Of course, it goes without saying that the technological idea is within the scope of the invention.

### INDUSTRIAL APPLICABILITY

The auction system and method according to the present invention can be employed in any of industries, in which the seller cannot rapidly increase the supplied quantity of goods for a request from a purchaser of goods or services. For example, no matter how great demand for a semiconductor device such as DRAM there is, it cannot be manufactured by more than a predetermined quantity from one production line, and it takes at least several months in order to increase the number of the production lines. Therefore, there happens unbalance between the demand and the supply. So, the present invention may be employed in such an industrial field of the semiconductor device. In other words, the present invention may be efficiently employed in industries of airplane, chemistry, petroleum, steel, automobile, semiconductor, textile, shipbuilding, electricity, hotel, manpower, and other industries, in which it is difficult to rapidly increase the quantity of production.

According to the present invention as described above, in industries, in which the sale and the purchase of goods are conducted according to the planned production, the seller can distribute the orders according to the production schedule, and can sell the goods at higher prices by conducting the auction according to an excessive demand when there happens the excessive demand. Further, the bidder can receive the goods, which he wants to purchase, at the time he want, only if the bidder make a bid with a high price in the auction.

While there have been illustrated and described what are considered to be preferred specific embodiments of the present invention, it will be understood by those skilled in the art that the present invention is not limited to the specific embodiments thereof, and various changes and modifications and equivalents may be substituted for elements thereof without departing from the true scope of the present invention.

1. An auction system comprising at least one terminal, a server, and an open-type network, the server comprising:
a goods database section for storing sales information of goods which a seller want to sell;
an order database section for storing purchase order information of registered selling goods which a bidder wants to purchase;
a selling goods register module for storing information about goods to be sold through input means of the terminal or the server in the goods database section;
a purchase order register and change module for storing purchase order information about goods to be purchased through the input means of the terminal in the order database section and for changing already registered information;
a production schedule arranging module for arranging a production schedule for the goods according to the purchase order information registered or changed by the purchase order register and change module;
a purchase waiting order assigning module for determining an order, whose production schedule has been arranged by the production schedule arranging module, as a purchase waiting order;
a purchase determined order selecting module for selecting a purchase determined order from purchase waiting orders;
an auction order selecting module for selecting an order, whose production schedule is arranged before a production initiating date and a delivery date of an excessive demand inducing order, as an auction order; and
an auction module for comparing unit bid prices of auction orders selected by the auction order selecting module each other, so as to exclude an order with a lowest bid price, judging if there exists an excessive demand by remaining orders except the order of the lowest price, and progressing an auction again until there exists no more excessive demand and classifying the remaining orders into purchase waiting orders when the excessive demand does not exist any more.

2. An auction system as claimed in claim 1, the server further comprising a schedule optimizing module for optimizing an arrangement of the production schedule in the system by rearranging the production schedule to be before and near each requested delivery date in already registered order information of a bidder, when there happen factors of changing the demand and supply due to reasons including a participation of a new order into the auction after the production schedule is arranged, an exclusion of an order while the auction progresses, a change in the ordered quantity of goods or a withdrawal of the order by a bidder, and a change in the produced quantity of goods by the seller.

3. An auction system as claimed in claim 1, the server further comprising an auction possibility judging module for judging if an excessive demand inducing order, for which a production schedule is not arranged by the production schedule arranging module, can participate in the auction or not, and for notifying that the excessive demand inducing order cannot participate in the auction and that the order has to be changed, when the auction is impossible.

4. An auction system as claimed in claim 1, wherein the goods database section stores information including at least one of names of goods and services to be sold by a seller, descriptions about the goods, expected daily producing quantities of the goods, waiting time for the purchase determination, a closing date of the sale, and starting prices of the goods, and the order database section stores information including at least one of names and unit bid prices of goods to be purchased, a delivery date, a purchased quantity of goods, and a processing state of the order.

5. An auction system as claimed in claim 1, wherein at least one of labors, which include reducing a quantity of goods to be purchased, delaying the delivery date, and elevating the unit auction price, is carried out, while a waiting time in an initial stage of registering the order is maintained, when the already registered information is changed by the purchase order register and change module.

6. An auction system as claimed in one of claims 1 to 5, wherein the production schedule arranging module arranges a production schedule of an order with a continuity of time or intermittently.

7. An auction system as claimed in one of claims 1 to 5, wherein the purchase determined order selecting module selects a purchase determined order, when a purchase waiting time has passed so that it is time of change from a purchase waiting order into the purchase determined order, or when the seller manually changes an order into the purchase determined order.

8. An auction system as claimed in one of claims 1 to 5, wherein, in a case where the order of the lowest price is selected by the auction module, an order with a smallest quantity is selected as the order of the lowest price when there exist at least two orders whose prices are equally lowest, while an order registered most lately is selected as the order of the lowest price when there exist at least two orders whose prices are equally lowest and whose quantities are the same.

9. An auction method by means of an auction system, the auction system comprising at least one terminal, a server, and an open-type network, the method comprising:
a selling goods register step, in which a seller inputs information about goods and service to be sold;
a purchase order register and change step, in which a bidder inputs purchase order information about goods which the bidder wants to purchase and changes already registered information;
a production schedule arranging step, in which the server arranges a production schedule for the goods according to the purchase order information registered or changed in the purchase order register and change step;
a purchase waiting order assigning step, in which an order whose production schedule has been arranged in the production schedule arranging step is defined as a purchase waiting order;
a purchase determined order selecting step, in which a purchase determined order is selected from purchase waiting orders;
an auction order selecting step, in which orders, whose production schedule is already arranged between a production initiating date and a delivery date of an excessive demand inducing order, and the excessive demand inducing order are selected as auction orders; and
an auction step, in which an auction is conducted for the auction orders selected in the auction order selecting step, so as to exclude an auction order with a lowest bid price, if there exists an excessive demand by remaining orders except the order of the lowest price is judged, and the auction is conducted again when there exists the excessive demand while the remaining orders are classified into purchase waiting orders when the excessive demand does not exist.

10. An auction system as claimed in claim 9, the method further comprising a schedule optimizing step, in which the production schedule in already registered order information of a bidder is rearranged to be before and near each purchase order's requested delivery date, so that an arrangement of the production schedule may be optimized, when there happen factors of changing the demand or supply due to reasons including a participation of a new order into the auction before an execution of the production schedule arranging step or after an execution of the auction step, an exclusion of an order while the auction progresses, a change in the ordered quantity of goods or a withdrawal of the order by a bidder, and a change in the produced quantity of goods by the seller.

11. An auction system as claimed in claim 9, the method further comprising an auction possibility judging step, in which whether an excessive demand inducing order, for which a production schedule is not arranged in the production schedule arranging step, can participate in the auction is judged, and that the excessive demand inducing order cannot participate in the auction and that the order has to be changed are notified when the auction is impossible.

12. An auction system as claimed in claim 9, wherein first information inputted in the selling goods register step includes at least one of names of goods and services to be sold by a seller, descriptions about the goods, expected daily producing quantities of the goods, waiting time for the purchase determination, a closing date of the sale, and starting prices of the goods, and second information inputted or changed in the purchase order register and change step includes at least one of names and unit bid prices of goods to be purchased, a delivery date, a purchased quantity of goods, and a processing state of the order.

13. An auction system as claimed in claim 12, wherein at least one of labors, which include reducing a quantity of goods to be purchased, delaying the delivery date, and elevating the unit auction price, can be carried out, while a waiting time in an initial stage of registering the order is maintained, when the already registered information is changed in the purchase order register and change step.

14. An auction system as claimed in one of claims 9 to 13, wherein, in the production schedule arranging step, a production schedule of a purchasing order is arranged with a continuity of time or intermittently.

15. An auction system as claimed in one of claims 9 to 13, wherein in the purchase determined order selecting step, a purchase determined order is determined, when a purchase waiting time has passed so that it is time of change from a purchase waiting order into the purchase determined order, or when the seller manually changes an order into the purchase determined order.

16. An auction system as claimed in one of claims 9 to 13, wherein, in a case where the order of the lowest price is selected in the auction step, an order with a smallest quantity is selected as the order of the lowest price when there exist at least two orders whose prices are equally lowest, while an order registered most lately is selected as the order of the lowest price when there exist at least two orders whose prices are equally lowest and whose quantities are the same.

17. A reverse auction system comprising at least one terminal, a server, and an open-type network, the server comprising:
a goods database section for storing purchase information of goods which a bidder want to purchase;
an order database section for storing sales order information of registered goods which a seller wants to sell;
a purchase goods register module for storing information about goods to be purchased through input means of the terminal in the goods database section;
a sales order register and change module for storing sales order information about goods to be sold through the input means of the terminal in the order database section and for changing already registered information;
a purchase schedule arranging module for arranging a purchase schedule for the goods according to the sales order information registered or changed by the sales order register and change module;
a sales waiting order assigning module for determining an order, whose purchase schedule has been arranged by the purchase schedule arranging module, as a sales waiting order;
a sales determined order selecting module for selecting a sales determined order from sales waiting orders;
a reverse auction order selecting module for selecting an order, whose goods sales quantity is arranged after a delivery date, from the sales waiting orders, as a reverse auction order; and
a reverse auction module for comparing unit sales prices of reverse auction orders selected by the reverse auction order selecting module one after another, so as to exclude an order with a highest sales price, judging if it is possible to conduct the reverse auction with remaining reverse auction orders except the order of the highest sales price, and progressing a reverse auction again when there exists an excessive supply while classifying the remaining orders into sales waiting orders when the excessive supply does not exist.

18. A reverse auction system as claimed in claim 17, the server further comprising a schedule optimizing module for optimizing an arrangement of the production schedule in the system by rearranging the production schedule to be before and near a requested delivery date in already registered order information of a bidder, when there happen factors of changing the demand and supply due to reasons including a participation of a new order into the reverse auction after the purchase schedule is arranged, an exclusion of an order while the reverse auction progresses, a change in the quantity of selling goods or a withdrawal of a sales order by a seller, and a change in the ordered quantity of goods by the bidder.

19. A reverse auction system as claimed in claim 17, the server further comprising a reverse auction possibility judging module for judging if an excessive supply inducing order, for which a purchase schedule is not arranged by the purchase schedule arranging module, can participate in the reverse auction, and for notifying that the excessive supply inducing order cannot participate in the reverse auction and that the order has to be changed by reducing the quantity of goods, advancing a supply date, or lowering the price, when the reverse auction is impossible.

20. A reverse auction method by means of a reverse auction system, the reverse auction system comprising at least one terminal, a server, and an open-type network, the method comprising:
a purchase goods register step, in which provided is a screen, through which a bidder who wants to purchase goods can input information about the goods to be purchased;
a sales order register and change step, in which provided is a screen, through which a seller can input sales order information about goods, which the seller wants to purchase, and can change already registered information;
a purchase schedule arranging step, in which the server arranges a purchase schedule for the order registered or changed in the sales order register and change step;
a sales waiting order assigning step, in which the order whose purchase schedule has been arranged in the purchase schedule arranging step is defined as a sales waiting order;
a sales determined order selecting step, in which a sales determined order is selected from sales waiting orders;
a reverse auction order selecting step, in which an order, whose supplying quantity is already arranged after a delivery date of an excessive supply inducing order, and the excessive supply inducing order are selected as reverse auction orders; and
a reverse auction step, in which a reverse auction is conducted for the reverse auction orders selected in the reverse auction order selecting step, so as to exclude a reverse auction order with a highest sales price, if there exists an excessive supply by remaining orders except the order of the highest sales price is judged, and the reverse auction is conducted again when there exists the excessive supply while the remaining orders are classified into sales waiting orders when the excessive supply does not exist.

21. A reverse auction system as claimed in claim 20, the method further comprising a schedule optimizing step, in which the purchase schedule is rearranged to be after and near a requested delivery date in already registered sales order information of a seller, so that an arrangement of the purchase schedule is optimized, when there happen factors of changing the demand and supply due to reasons including a participation of a new order into the reverse auction before an execution of the purchase schedule arranging step or after an execution of the reverse auction step, an exclusion of a sales order while the reverse auction progresses, a change in the sales quantity of goods or a withdrawal of the sales order by a seller, and a change in the purchased quantity of goods by the purchaser.

22. A reverse auction system as claimed in claim 20, the method further comprising a reverse auction possibility judging step, in which, when there exists an excessive supply inducing order, for which a purchase schedule is not arranged in the purchase schedule arranging step, if the excessive supply inducing order can participate in the reverse auction is judged, and that the excessive supply inducing order cannot participate in the reverse auction and that the sales order has to be changed are notified when the reverse auction is impossible.
